(19) United States
(12) Patent Application Publication
(10) Pub. No.: US 2010/0250570 A1
(43) Pub. Date: Sep. 30, 2010

(54) APPARATUS AND METHOD FOR MANAGING PRESENCE INFORMATION IN MOBILE COMMUNICATION SYSTEM

(75) Inventor: Wook-Hyun JEONG, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/730,315

(22) Filed: Mar. 24, 2010

(30) Foreign Application Priority Data
Mar. 26, 2009 (KR) 10-2009-0025801

(51) Int. Cl. G06F 15/16; G06F 17/30

(52) U.S. Cl. 707/758; 709/219; 707/E17.014

(57) ABSTRACT

An apparatus and method for managing presence information in a mobile communication system includes inputting media data to be transmitted to another terminal, confirming presence information that corresponds to the inputted media data in a presence database representing a correspondence relationship between media data and presence information, and requesting a presence information update of the terminal by transmitting the confirmed presence information to a presence server.

### CLAIM OF PRIORITY

This application claims priority from an earlier Korean patent application filed in the Korean Intellectual Property Office on Mar. 26, 2009 and assigned Serial No. 10-2009-0025801, the entire disclosure of which is hereby incorporated by reference in its entirely.

### BACKGROUND OF THE INVENTION

1. Field of the Invention

The present invention relates generally to an apparatus and method for managing presence information in a mobile communication system. More particularly, the present invention relates to an apparatus and method for updating presence information in a mobile communication terminal.

2. Description of the Related Art

Recent IP Multimedia Subsystem (IMS) based applications perform call establishment through a Session Initiation Protocol (SIP) based on presence information about a plurality of terminals and transmit/receive media through a Real-time Transport Protocol (RTP). Here, the presence service is a service that provides presence information, which includes a user position, a user status (e.g. a communication available status, a communication unavailable status, an emotion status, a job status), and access rules, to another user. An example of such a service using the presence information includes an instant messenger used as a communication means among the latest Internet users. The instant messenger provides a service that allows on-line Internet users to exchange messages using the presence information.

A user of the IMS based application based on the presence service typically sets up his status through a user interface in a terminal, and thus can update his current status registered in a presence server for managing the presence information of each user. That is, when a user “A” directly sets up his status through a user interface provided from a terminal, the directly-set status information is then registered in the presence server and then transmitted into other terminals connected to the presence server. Thus, the presence information of the user A is updated in the other terminals as well as the terminal accessed by the user. At this point, depending on how accurately a user interface provided from a terminal is described, a user controls his presence information by directly setting up the user status, user position, and access rules by each group or each user.

That is, according to the prior art presence service, terminals that need to update presence information of a user or terminals that receive presence information have to directly manage the presence information through user interfaces included in the terminals.

### SUMMARY OF THE INVENTION

An aspect of the present invention is to an apparatus and method for managing presence information in a mobile communication system.

Another exemplary aspect of the present invention is to provide an apparatus and method for automatically updating presence information using transmission media data in a mobile communication system.

Another exemplary aspect of the present invention is to provide an apparatus and method for obtaining presence information of other party terminals using transmission media data in a mobile communication system.

According to an exemplary aspect of the present invention, a terminal method of managing presence information in a mobile communication system includes: an input unit of a first terminal receiving media data for transmission to a second terminal; confirming presence information that corresponds to the received media data in a presence database representing a correspondence relationship between the media data and presence information; and requesting an update of the presence information of the first terminal by transmitting the confirmed presence information to a presence server.

According to another exemplary aspect of the present invention, a terminal device for managing presence information in a mobile communication system includes: an input unit inputting media data for transmission to another party terminal; a database representing a correspondence relationship between media data and presence information; and a control unit controlling to request a presence information update of the terminal itself by confirming presence information corresponding to the inputted media data in the database and transmitting the confirmed presence information to a presence server.

### BRIEF DESCRIPTION OF THE DRAWINGS

The above and other exemplary aspects, features and advantages of the present invention will become more apparent from the following detailed description when taken in conjunction with the accompanying drawings in which:

FIG. 1 is a view illustrating a signal flow for updating presence information in a mobile communication system according to an exemplary embodiment the present invention;

FIG. 2 is a view illustrating a signal flow for obtaining presence information of the other party terminal in a mobile communication system according to an exemplary embodiment the present invention;

FIGS. 3A and 3B illustrate a mapping relationship between media data to be transmitted and received and presence information in a mobile communication system according to an exemplary embodiment of the present invention;

FIG. 4 is a block diagram of a mobile communication terminal according to an exemplary embodiment of the present invention;

FIG. 5 is a flowchart illustrating operational procedures of a mobile communication terminal according to an exemplary embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. Also, descriptions of well-known functions and constructions may be omitted for clarity and conciseness so as not to obscure appreciation of the present invention by a person of ordinary skill in the art.

It is to be understood that the singular forms “a”, “an”, and “the” include plural references unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Hereinafter, an apparatus and method for updating presence information by analyzing media data that terminals transmit and receive in a mobile communication system will be described.

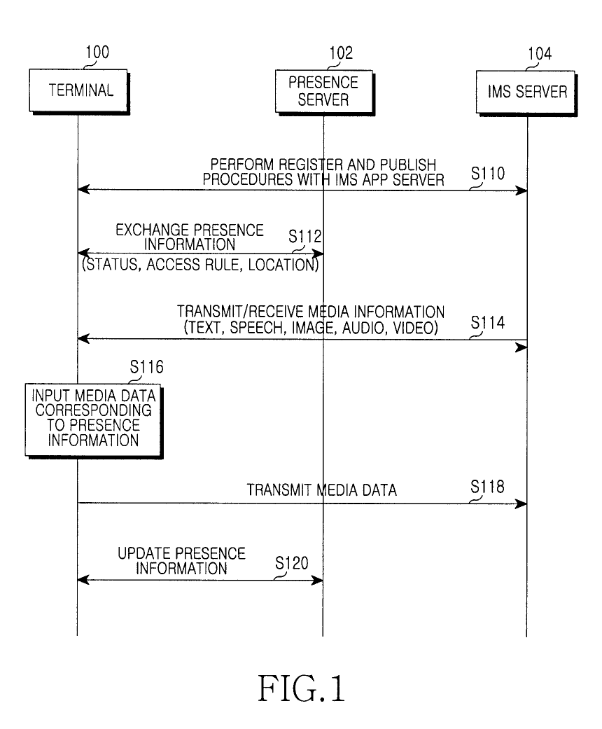

FIG. 1 is a view illustrating a signal flow for updating presence information in a mobile communication system according to the present invention.

Referring now to FIG. 1, once an IP Multimedia Subsystem (IMS) based application starts, a first terminal 100 registers by performing REGISTER and PUBLISH processes with an IMS server 104 in operational step S110.

Next, the terminal 100 updates presence information based on an initial setting by performing a procedure for exchanging the presence information with the presence server 102 in operational step S112. The set present information includes user status information, position information, and privacy rules related to the presence information of the other terminal.

Next, the terminal 100 exchanges information about media (e.g., service type and media type information) to be transmitted or received to or from the other terminals through the IMS server 104 in operational step S114. For example, information on media data to be transmitted includes identification as to whether the media data comprises text, voice, image, audio, or video is transmitted.

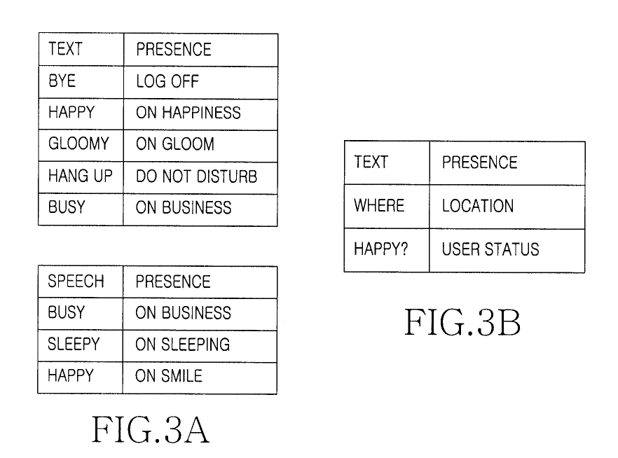

Then, the terminal 100 receives media data corresponding to presence information from a user in operational step S116. Here, the terminal 100 confirms what kind of presence information the inputted media data is by comparing the inputted media data from the user with the predetermined presence database (DB). Here, the presence DB, as illustrated in FIG. 3A, is a DB representing a correspondence relationship between the media data and the presence information, and thus the presence DB for each media type may be stored in the terminal. Here, the presence DB may be stored when a terminal is designed, and may be additionally stored, deleted, and edited by a user. For example, while the terminal 100 uses an instant messaging service, if a user inputs “I'm busy” in a text input unit, the inputted text is compared with the pre-stored presence DB as illustrated in FIG. 3A. Then, the media data of “busy” among the inputted text of “I'm busy” corresponds to user status information (i.e., “on Business”) among the presence information.

Later, the terminal 100 transmits the inputted media data to the other (i.e. second) terminal (not shown) through the IMS server 104 in operational step S118, and the confirmed presence information is transmitted to the presence server 102 to automatically update the presence information of the user himself in operational step S120. For example, the terminal 100 transmits “on Business” (i.e., user status information obtained by the input of “I'm busy”) to the presence server 102 to update the presence information of the user himself.

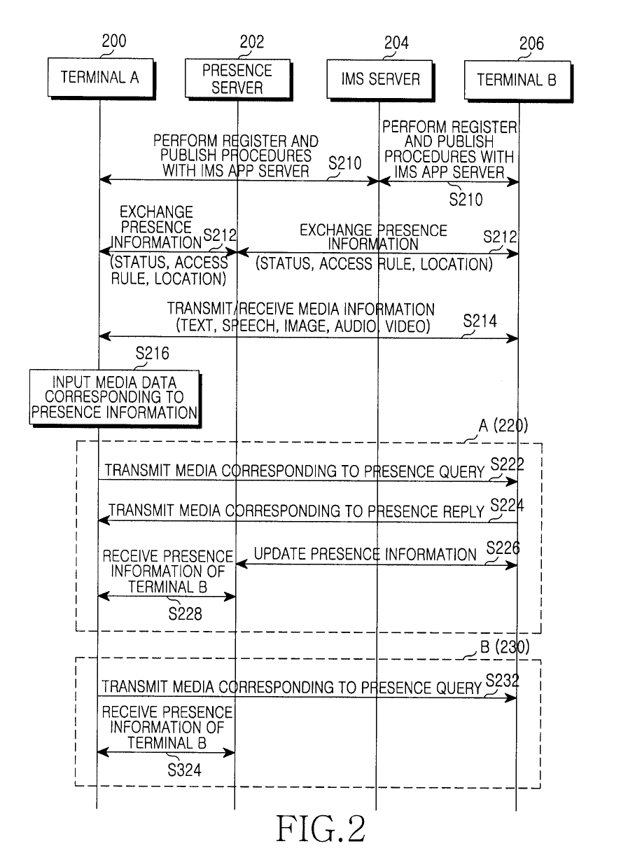

FIG. 2 is a view illustrating a signal flow for obtaining presence information of the other party terminal in a mobile communication system according to the present invention.

Referring now to FIG. 2, once an IMS based application starts, a terminal A 200 and a terminal B 206 register by performing REGISTER and PUBLISH processes with an IMS server 204 in operational step S210.

Next, the terminal A 200 and terminal B 206 update presence information based on an initial setting by performing a procedure for exchanging the presence information with a presence server 202 in operational step S212. The set present information includes user status information, position information, and privacy rules related to presence information about the other party terminal.

Next, the terminal A 200 and the terminal B 206 exchange information about media (that is, service type and media type information) to be transmitted or received to or from the other terminal through the IMS server 204 in operational step S214. For example, information on whether media data to be transmitted is text, voice, image, audio, or video is transmitted.

Then, the terminal A 200 receives media data corresponding to a presence query from a user in operational step S216. Here, the terminal A 200 confirms that what kind of media data corresponding to the presence information the inputted media data is by comparing the inputted media data from the user with the predetermined presence DB 202. Here, the presence DB, as illustrated in FIG. 3B, is a DB representing a correspondence relationship between the media data and the presence query, and thus a presence query DB for each media type may be stored in the terminal. Here, the presence query DB may be stored when a terminal is designed, and may be additionally stored, deleted, and edited by a user. For example, while the terminal A 200 uses an instant messaging service, if a user inputs “Where are you” in a text input unit, the inputted text is compared with the pre-stored presence query DB as illustrated in FIG. 3B. Then, it is confirmed that the media data of “Where” among the inputted text of “Where are you” corresponds to “Location” for asking user position information among the presence query.

Next, through two methods, the terminal A 200 obtains position information of the terminal B 206. First, in relation to the method A 220, the terminal A 200 transmits inputted media data corresponding to a presence query to the terminal B 206 in operational step S222, and the terminal B 206 receives the transmitted presence query and then transmits media data corresponding to the presence query to the terminal A 200. For example, if the terminal A 200 transmits media data of “where are you?” to the terminal B 206, the terminal B 206 receives media data of “home” from a user and then transmits it to the terminal A 200.

At this point, since the terminal B 206 receives media data corresponding to a reply for the presence query from the user, and then confirms what kind of presence information the inputted media is. Then, it proceeds to operational step S226. The confirmed presence information is transmitted to the presence server 202 to automatically update the presence information of the user himself. Here, the terminal B 206 confirms what kind of presence information the inputted media data is through the predetermined presence DB as illustrated in FIG. 3A. Next, the terminal A 200 requests the presence information of the terminal B 206 from the presence server 202 through a watcher and receives the presence information of the terminal B 206 registered in the presence server 202 in operational step S228.

Next, in relation to the method B 230, the terminal A 200 transmits inputted media data corresponding to a presence query to the terminal B 206 and request the presence information of the terminal B 206 from the presence server 202 through the watcher in operation 232 and receives the presence information of the terminal B 206 registered in the presence server 202 in operation 234.

That is, the terminal A 200 receives the present information that the terminal B 206 directly updates in response to the user inputted presence query or receives the presence information of the terminal B 206 that is currently stored in the presence server 202.

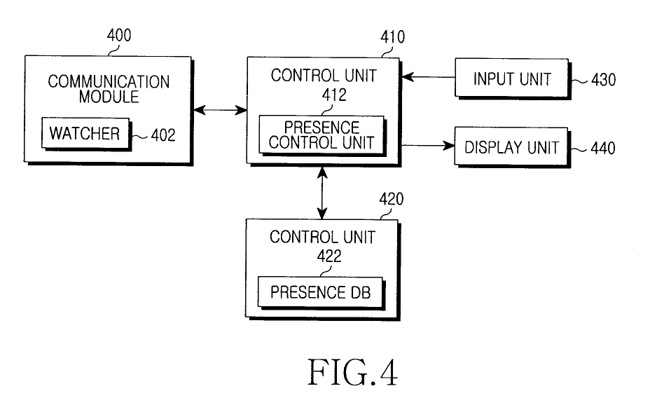

FIG. 4 is a block diagram of a mobile communication terminal according to an exemplary embodiment of the present invention.

Referring to FIG. 4, the terminal includes a communication module 400, a control unit 410, a storage 420, an input unit 430, and a display unit 440.

The communication module 400 processes a wireless signal that is transmitted and received in response to control of the control unit 410. That is, the communication module 400 converts a signal provided from the control unit 410 into a high frequency signal and transmits the converted signal into a corresponding node, and also converts a received high frequency signal into a baseband signal and transmits the converted signal into the control unit 410. Especially, the communication module 400 includes a watcher 402, and thus performs a function for requesting presence information about other terminals from a presence server and obtains the requested presence information.

The control unit 410 controls and processes general operations of the terminal and preferably includes a presence control unit 412. The control unit 410 recognizes media data inputted during IMS APP and automatically updates the presence information of the terminal. The control unit 410 controls and processes a function for automatically obtaining the presence information of the other party terminal.

That is, the presence control unit 412 recognizes and analyzes the media data inputted from a user and determines whether or not the inputted media data comprises presence information of his own terminal or a presence query for obtaining the presence information of the another party terminal. Later, the presence control unit 412 controls and processes a function for updating the presence information of a terminal registered in the presence server if the inputted media data are the presence information of the his own terminal. If the inputted media data is the presence query, the presence control unit 412 controls and processes a function for obtaining the presence information of the other party terminal through the watcher 402. At this point, the presence control unit 412 determines whether or not inputted media data are the presence information of his own terminal or the presence query for obtaining the presence information of the other party by comparing recognition and analysis results of the media data with the presence DB 422 in the storage 420.

The storage 420 stores programs and various data for general operations of the terminal, and stores the presence DB 422 according to the present invention. The presence DB 422, as illustrated in FIGS. 3A and 3B, is a DB representing a correspondence relationship between media data and presence information or between media data and a presence query. The presence DB 422 for each media type may be stored in the storage 420. Here, the presence DB 422 may be stored when a terminal is designed, and may be updated by a user.

The input unit 430 receives media data from a user and provides the received data to the control unit 410. The input unit 430 preferably includes at least one of a microphone for inputting voice data, a camera for inputting image data, and a keypad for inputting text data.

The display unit 440 displays status information and various information generated during an operation of the terminal, and also displays the presence information of the terminal and the other party terminal according to the present invention.

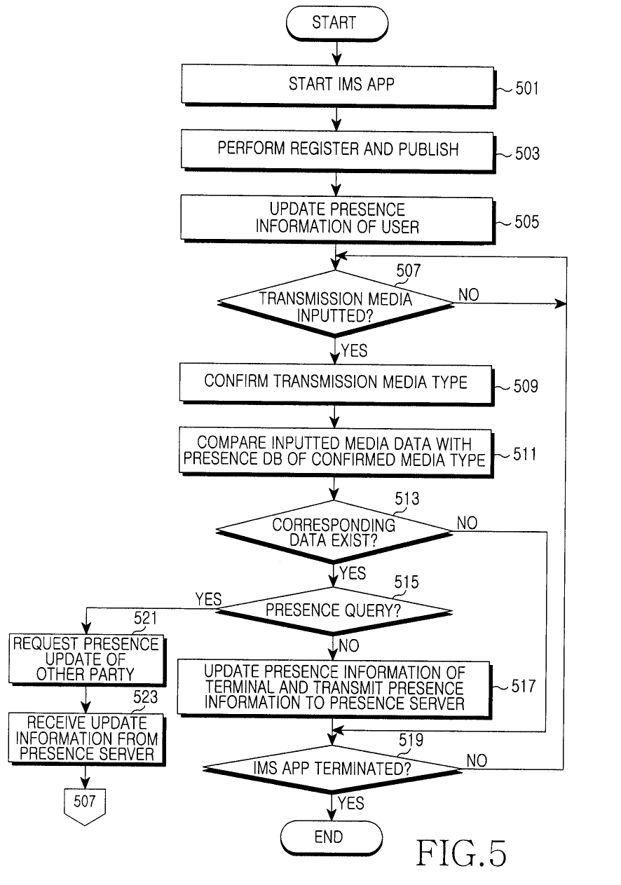

FIG. 5 is a flowchart illustrating operational procedures of a mobile communication terminal according to an exemplary embodiment of the present invention.

Referring now to FIG. 5, at step 501 once an IMS based application starts in, and at step 503 a terminal registers by performing REGISTER and PUBLISH processes with an IMS server.

Next at step 505, the terminal performs a procedure for exchanging presence information with a presence server to update user presence information according to an initial setting and exchange information media (i.e., service type and media type information) to be transmitted and received to and from the other terminal through the IMS server.

At step 507, the terminal examines whether or not media data to be transmitted is inputted from a user. When the media data is inputted, the method proceeds to step 509 and the inputted media type to be transmitted is confirmed. Then, at step 511 the inputted media data is compared with a predetermined presence DB of the confirmed media type.

At step 513, the terminal determines whether there is media data corresponding to the inputted media data in the presence DB based on a comparison result of the inputted media data and the presence DB. If there is no media data corresponding to the inputted media data in the presence DB based on the comparison result, the method proceeds to step 519 that asks whether the IMS application is terminated. If there is corresponding media data, it proceeds to operation 515 to determine whether the inputted media data is a presence query for obtaining presence information of the other party terminal.

If the inputted media data is not a presence query, then at step 517, after the presence information corresponding to the inputted media data in the presence DB is confirmed, the terminal updates the presence information in the terminal and transmits the presence information to the presence server to update the terminal presence information stored in the presence server.

For example, when voice data of “I'm happy” is inputted from the user, the terminal confirms that there is the same data of “happy” among the data of “I'm happy” in the presence DB as illustrated in FIG. 3, and updates the presence information in the terminal and the presence information stored in the presence server with the presence information of “on happiness” corresponding to the “happy”.

Next, when the IMS based APP is not terminated after examination of the IMS based APP termination in operation 519, then at step 507, when the IMS based APP is terminated, an algorithm according to the present invention is terminated.

On the contrary, if the inputted media data is a presence query, then at step 521 the terminal confirms the presence query information corresponding to the inputted media data in the presence DB, and then requests the presence server to update the presence information of the other party terminal through a watcher.

Next, at step 523 the terminal receives the presence information of the other party terminal from the presence server to update the other party terminal presence information in the terminal. For example, when text data of “Are you happy?” is inputted from the user, as illustrated in FIG. 3, the terminal confirms that data of “happy?” exists among data of “Are you happy?” in the presence DB and also confirms that the data of “happy?” corresponds to a presence query for obtaining the presence information of the other party terminal. Next, the terminal confirms that it is an information query related to user status information corresponding to the data of “happy?” and requests user status information of the other party terminal from the presence server through a watcher and received the user status information.

Next at step 519, when the IMS based APP is not terminated after examination of the IMS based APP, the method proceeds to step 507. When the IMS based APP is terminated, an algorithm according to the present invention is terminated.

The present invention analyzes typically transmitted/received media data in a mobile communication system to automatically update presence information, such that a user updates the presence information without an additional operation for updating the presence information.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain preferred exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A terminal method of managing presence information in a mobile communication system, the method comprising:
an input unit of a first terminal receiving media data for transmission to a second terminal;
confirming presence information that corresponds to the received media data in a presence database representing a correspondence relationship between the media data and presence information; and
requesting an update of the presence information of the first terminal by transmitting the confirmed presence information to a presence server.

2. The method of claim 1, wherein the first terminal confirms a type of presence information by comparing the received media data with the presence database.

3. The method of claim 1, wherein the presence database stores data for each media type in the terminal and is updatable by a user.

4. The method of claim 1, further comprising:
determining wherein the confirmed presence information comprises a presence query for obtaining presence information of the second terminal;
requesting presence information of the second terminal by transmitting a frequency query to the presence server if the confirmed presence information is the presence query; and
receiving the presence information of the second terminal.

5. The method of claim 1, wherein the media data comprises at least one of voice, image, and text.

6. The method of claim 3, wherein the first terminal transmits the media data to the second terminal through an IP Multimedia Subsystem (IMS) server.

7. The method of claim 1, wherein the first terminal requests the presence information of the second terminal from the presence server through a watcher, and receives the presence information of the second terminal registered in the presence server.

8. The method of claim 1, wherein the presence information comprises user status information.

9. The method of claim 1, wherein the first terminal recognizes and analyzes the received media data determines whether the received media data comprises presence information of the first terminal or a presence query for obtaining the presence information of the second terminal.

10. An apparatus for managing presence information in a mobile communication system, the device comprising a first terminal including:
an input unit for inputting media data for transmission from the first terminal a second terminal;
a presence database representing a correspondence relationship between media data and presence information; and
a control unit controlling a request to update presence information of the first terminal by confirming presence information corresponding to the inputted media data in the presence database and transmitting the confirmed presence information to a presence server.

11. The apparatus of claim 10, wherein the presence database stores data for each media type and is updatable by a user.

12. The apparatus of claim 10, wherein:
the control unit determines whether the confirmed presence information comprises a presence query for obtaining presence information of the other party terminal after presence information corresponding to the inputted media data is confirmed.

13. The apparatus of claim 12, further comprising:
a watcher transmitting the presence query to the presence server to request presence information of the second party terminal and receiving the presence information of the second party terminal if the presence information comprises the presence query.

14. The apparatus of claim 10, wherein the input unit comprises at least one of a microphone for inputting a voice, a camera for inputting an image, and a keypad for inputting a text.

15. The apparatus of claim 10, wherein the control unit recognizes media data inputted during an IP Multimedia Subsystem (IMS) application and automatically updates the presence information of said first terminal.

16. The apparatus of claim 10, wherein first terminal transmits the media data to the second terminal through an IP Multimedia Subsystem (IMS) server.
